(19) United States
(12) Patent Application Publication
(10) Pub. No.: US 2003/0200126 A1
(43) Pub. Date: Oct. 23, 2003

(54) Service means of providing luggage container

(76) Inventors: Ding-Bang Luh, Taipei (TW); Chien-Hsu Chen, Taipei (TW); Meng-Dar Shieh, Tainan (TW)

Correspondence Address: Ding-Bang LUH & Joint Inventors, P. O. Box No. 6-57, Junghe, Taipei 235, TW

(21) Appl. No.: 10/409,173

(22) Filed: Apr. 9, 2003

(30) Foreign Application Priority Data
Apr. 19, 2002 (TW) 91108022

(51) Int. Cl. G06F 17/60

(52) U.S. Cl. 705/5; 705/26

(57) ABSTRACT

A service means for providing luggage containers includes an established luggage management organization having management authority over luggage containers, and the luggage containers may be designed according to characteristics of different luggage. The luggage management organization accepts reservations and authorizations of a user to provide a certain quantity of luggage containers for an agreed period for the user to pack luggage therein. The luggage management organization retrieves the luggage containers after the user finishes using the luggage containers, thereby eliminating inconveniences of storage, purchase and repair of luggage containers for the user.

### BACKGROUND OF THE INVENTION

(a) Field of the Invention

The invention relates to a service means for providing luggage containers, and more particularly, to a service means for providing luggage containers, wherein a luggage management organization having management authority over the luggage containers is established, so as to enable customers to carry most suitable luggage containers in journeys by providing customers or withdrawing from customers with appropriate luggage containers according to customers' needs at different stops in journeys.

(b) Description of the Prior Art

As a result of convenient traffic systems and flourishing of transportations, distances between various locations in the world are significantly shortened, and a global village has gradually taken shape. There are plenty of chances for everyone to travel for activities such as pleasure, shopping, business and education, both domestically and internationally. When carrying out these activities, personal luggage is frequently required. Currently, travelers are obligated to buy luggage containers (luggage trunks) beforehand depending on the amount of luggage to be taken along with in those luggage containers. Such conventional method of providing luggage containers by oneself in fact has quite a number of inconveniences, such as:

1. “Unsymmetrical amount of luggage” occurs in departure and return trips. For traveling for pleasure as an example, luggage trunks brought on the departure trip become inadequate on the return trip because of spaces taken up by newly bought local souvenirs, and it is then necessary to purchase additional luggage trunks for packing. Also, for businessmen who travel abroad to participate trade shows, it is possible that luggage trunks brought along in departure trips are stuffed with certain amounts of materials for the trade shows, but the luggage trunks may then appear to be too many for that the materials for trade shows are usually distributed to visitors coming the trade shows; carrying such empty cases on return trips are rather troublesome and redundant.

2. After journeys, unused luggage trunks occupy great amounts of home spaces; especially in the modern society in cities with dense population and home spaces are somewhat limited, and no one is willing to see those unused luggage trunks take up the already limited home spaces. Above all, luggage trunks only come into use during trips away from home, and idle duration thereof is far longer than employed duration thereof. It is evident that preparation of extra home spaces for preserving the luggage trunks having long idle duration but short employed duration is quite unfitting.

3. In occurrence of damages of luggage trunks (wheels, locks or handles), it is unlikely that users have the capability of fixing those problems, not to mention that maintenance and repairing thereof can become even more awful when out of town. Therefore, it is frequently observed that users discard luggage trunks due to only damages of small components of the luggage trunks, and thus the luggage trunks really have not served their proper uses as well as being non environmental friendly with all the disposals thereof.

4. Internal compartments in current luggage trunks are not exactly designed to meet needs of various types of people (travelers, businessmen, and students). Users are left with no choices but to yield oneself to existing compartment in order to pack luggage, and hence uses of current luggage trunks can be very awkward.

5. During shipment of luggage, unfound or delayed luggage is not considered rare. It is necessary that users improvise by buying additional everyday commodities or clothes as a temporary solution, and moreover, such conditions may be worsened when one is at a foreign place.

6. For airline companies, luggage strips are attached to luggage for shipment. However, the luggage strips are likely to come off, thus making unfound luggage happen one after another. Under present shipment mechanisms, chances of recovering the lost luggage is indeed extremely minute.

7. Luggage is placed on rotating belts in continuous rotations such that owners may pick it up upon arrival at destination airports. However, in the lack of good identification mechanisms, only distinguishing by naked eye observations are available at the moment, and therefore mistakes of picking up wrong luggage trunks that may lead to further unnecessary misunderstandings are also quite recurrent.

8. It is almost impossible to design luggage trunks with respect to particular personal belongings in order to offer most perfect packing. For example, certain fragile luggage needs luggage trunks having better designs of shock absorbent effects and protection, which are still inaccessible using present luggage trunks. As a result, fragile objects can only be carried close to one, and thus further adding more troubles during journeys.

9. For journeys having rushed schedules, travelers may not have enough time to buy local souvenirs as gifts for friends and relatives. Even if spare time is found to shop for the souvenirs, it still remains as an inconvenience as how to carry them on return trips.

10. Sizes of luggage trunks allowed for boarding are regulated in various airports, and if travelers use nonconforming luggage trunks for boarding due to failure of checking related details in advance, certain important personal luggage may not be boarded.

### SUMMARY OF THE INVENTION

Therefore, in the view of the aforesaid shortcomings of prior luggage handling, the primary object of the invention is to provide a luggage container access mechanism of “acquisition upon use and return after use, wherein a luggage management organization is responsible for management of a service means for providing luggage containers, and users are enabled to acquire short-term user right for suitable luggage containers from the luggage management organization according to nature and requirements of users' journeys.

### BRIEF DESCRIPTION OF THE DRAWINGS

FIG. 1 shows a flow chart of the implementation steps according to the invention.

FIG. 2 shows a schematic view illustrating the implementation of a luggage container according to the invention.

### DETAILED DESCRIPTION OF THE PREFERRED EMBODIMENTS

To better understand the object, functions and techniques of the invention, descriptions shall be given with the accompanying drawings below.

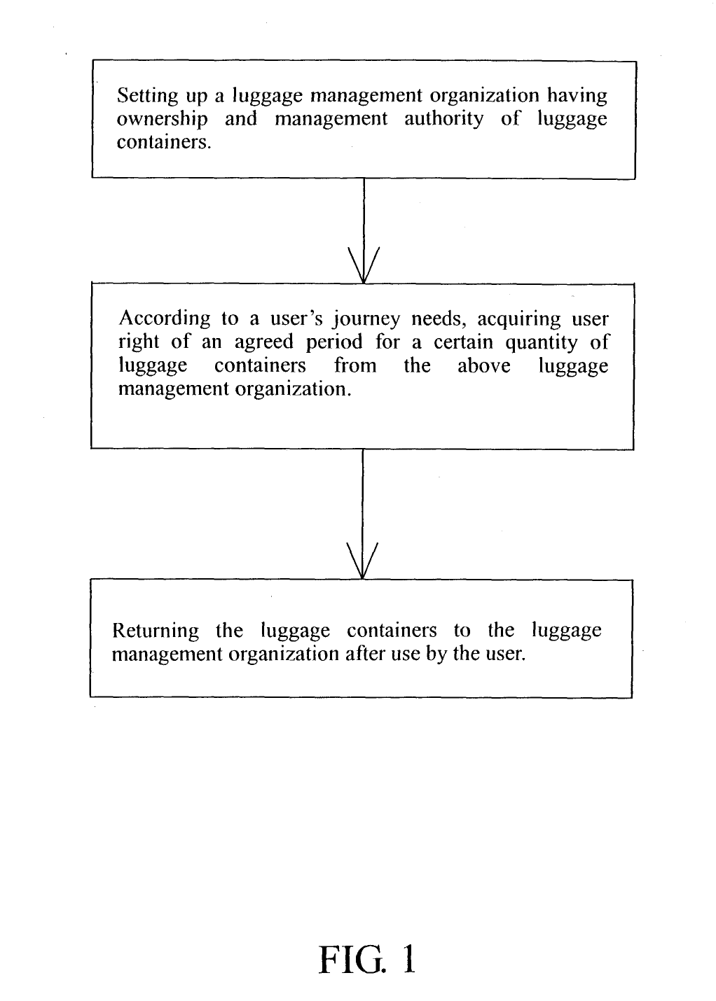

Referring to FIG. 1, the invention comprises the steps of:

a. setting up a luggage management organization having ownership and management authority of luggage containers;

b. according to a user's journey needs, acquiring user right of an agreed period for a certain quantity of luggage containers from the above luggage management organization; and

c. returning the luggage containers to the luggage management organization after use by the user.

From the above, the luggage management organization in step a has ownership and management authority of certain quantities of luggage containers, and branch offices thereof may be established at places in the world, so as to facilitate supplies and retrieves of luggage containers. The luggage containers may be planned and designed to have distinct features according to users' needs. For instance, the luggage containers may be shockproof; fireproof, waterproof, or even have high degrees of safety. Other factors namely sizes and materials are also taken into plan and design considerations to better offer users with perfect luggage containers.

In step b, the user makes a reservation for luggage containers for an agreed period at the aforesaid luggage management organization according to one's needs such location of departure, midpoint of journey or destination of journey. The luggage management organization then provides the user with luggage containers requested for packing. Procedures of user right acquisition of the user may be completed by paying one-time rental fees, annual member fees or offered by the luggage management organization as free of charge. Wherein, the free of charge method may be applied in luggage management organizations subordinate to certain airline companies or travel agencies, which provide customers with complimentary luggage containers in order to impress customers with better value-added services. In addition, the user may make a reservation at the luggage management organization in person, through fax, Internet or emails, and the details including quantity, specifications, delivery date and time, delivery address and recipient of luggage containers are confirmed in the process. Payments can be made by cash, checks, credit cards or telegraphic transfers, and payment terms such as before delivery, after delivery, periodical settlements or member fees are also agreed by both parties.

In step c, the user may return all rental luggage containers back to the luggage management organization at a midpoint of journey, destination of journey or when having returned from journey, depending on the user's needs.

Apart from the main steps as described above, the invention further comprises other additional steps of implementation, so as to make the entire mechanism more valuable for industrialists. The additional steps shall be described hereunder.

After the user completes reservation procedures at the luggage management organization, the luggage management organization may deliver the required luggage containers to a location designated by the user (the user's home or a staying hotel, for instance), or the user may come to the luggage management organization to pick up the required luggage containers.

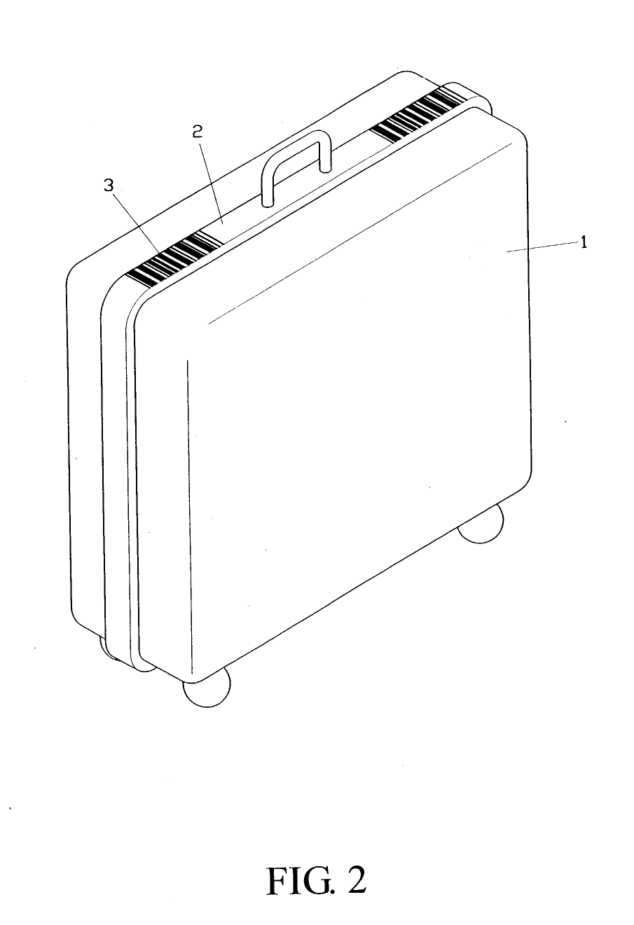

The luggage containers are entirely planned and designed by the luggage management organization, and therefore in order to increase identification efficiency of the luggage containers during shipment, certain areas on the luggage containers may be reserved for attaching identification devices or records, such as sensor chips, fingerprint identification chips and barcodes. Referring to FIG. 2, a luggage trunk 1 is reserved with adhesion region 2 at the periphery thereof for attaching a barcode 3. During shipment of the luggage trunk 1, the identification of the information thereof is made more effective using the barcode 3, and the barcode 3 in replacement of conventional luggage strips is unlikely of falling off. For any unfound luggage during shipment, the barcode 3 also helps finding the luggage trunk 1. Furthermore, in order to elevate the identification rate of the luggage containers, the luggage management organization may dispose identification chips in the luggage containers, whereas the sensor chips corresponding to the identification chips are given to the user. In this way, when the user waits at rotating luggage stands, the user is able to know approaching of one's luggage through signals sent by the sensor chips. If large quantities of luggage containers are leased by the luggage management organization, there are bound to be numerous of luggage containers of the same type, and the identification chips and sensor chips may then come into use by corresponding with each other, thereby preventing mistakes or thefts of luggage.

Because the leased luggage containers are circulated around major airports, stations, harbors and hotels in the world, and advertising effects t brought about are rather immense. Since the aforesaid luggage management organization owns huge numbers of luggage containers, the outer casings of the luggage containers may be planned as advertising-orientated and may be leased to specific vendors for regular advertisements, and thus developing tremendous commercial benefits. Beside the advertising purpose, the outer casings of the luggage containers may also have logos of corporate identification system (CIS) for corporations such as airline companies, and hence promoting service qualities of the corporation.

If the users are members of a group (for example, tour groups), the luggage management organization may provide the group members with luggage containers having same styles and colors, or even names of the group or tour description on the luggage containers when necessary in order to characterize the group. Also, by using luggage containers of same specifications, the tour captain may more easily manage, ship and declare luggage of this group.

For any damaged luggage containers, the luggage management organization is responsible for repairing and replacing the luggage containers to fully make uses thereof. At the same time, unified repairs are comparatively more economical for that they have lower production cost.

Generally users are prone to buy souvenirs in foreign places. However, users are reluctant to carry souvenirs in large quantities or large volumes. In this case, the luggage management organization may act as an agent and place the souvenirs in souvenir containers that are delivered and shipped to locations designated by the use, and thus reducing the burden of the user during traveling. Or, if the user cannot find spare time to purchase local souvenirs desired due to tight schedules, the luggage management organization may also make the purchases on the user's behalf, and deliver the souvenirs to the user in person or by shipment.

For users who have unfound luggage, the luggage management organization shall assist in finding the unfound luggage using the aforesaid barcode, and may also provide the user with light luggage as a contingency plan in order to prevent inconvenience of having the user to purchase commodities in time of emergency at foreign places.

In addition to services of rental luggage containers, the luggage management organization may also provide services of short-distance luggage delivery. That is, the luggage management organization may be in charge of delivering the luggage containers from a designated location to a location of luggage departure, or from a location of luggage departure to a designated location. For instance, after the user acquires the luggage containers and finishes packing, the luggage management organization may provide service of delivery from the user's home to an airport (harbor or station), or from a destination airport (harbor or station) to the user's staying hotel. The user may then feel quite pleasant during the journey and enjoy greater sense of freedom without burdens of luggage.

At any point of a journey, if increases and decreases in quantities of luggage containers are wished, or if any luggage containers are damaged, the luggage management organization is able to provide emergency measures by quickly supplementing, retrieving, replacing or repairing the required luggage containers.

In order to provide users with a multiple of choices with conveniences and to fulfill requirements of journeys, rental periods of the luggage containers may be one-way, partial journey or entire journey.

Conclusive from the above, the invention has the following advantages:

1. Issue of “unsymmetrical amount of luggage” of departure and return trips is solved. Users are always provided with most suitable luggage containers of appropriate quantities through the characteristic of increasing or decreasing the quantities of luggage containers by the luggage management organization at the user's wish, and therefore perplexities of over-supply and deficit are non-existent.

2. The luggage containers do not occupy the user's home spaces. The user returns the luggage containers to the luggage management organization after returning from a trip, and therefore not only home spaces are unoccupied, but expenses for purchasing luggage containers are also saved.

3. The luggage containers are effectively maintained and repaired in order to keep the conditions thereof perfect and to make the best uses thereof. At the meantime, purchase and maintenance costs are reduced for avoiding unnecessary disposal causing environmental problems.

4. Internal compartment of the luggage containers may have different designs to accommodate needs of various people (travelers, businessmen and students).

5. Wherever necessary, emergency luggage containers may be provided for the users in order to avoid inconveniences of having to make purchases in foreign places.

6. Luggage information may be read and identified quickly by introducing the barcode mechanism, and the barcode may also effectively help finding unfound luggage.

7. Picking up of luggage is made more convenient, safe and efficient using the identification chips and sensor chips by introducing the identification system.

8. Special luggage containers, for example, shock-absorbent luggage containers for fragile objects, are provided at users' choices to reduce perplexities of the users of having to carry those fragile objects.

9. Purchase services are provided. For users who do not have spare time to shop for local souvenirs, the local luggage management organization may make purchases or even deliveries for the users.

10. Short-distance luggage delivery services are provided. The luggage management organization may provide services of luggage delivery to and from airports, so that the users may have easy and convenient trips.

11. Luggage information services are provided. The luggage management organization supplies users with luggage regulations of various airports in order to prevent the users from bringing luggage nonconforming to the regulations.

12. The luggage containers have strong circulation, and thus giving enormous advertising and publicity effects that further generate tremendous commercial benefits.

13. The luggage management organization provides members of a same specific group (tour group, for example) with luggage containers of same specifications or labels according to requirements. Not only characteristics of the group are promoted, but it is also made easy for the tour captain to identify luggage of the group members. Also, luggage in shipment or to be picked up is given with good distinguishing ability as well.

It is of course to be understood that the embodiment described herein is merely illustrative of the principles of the invention and that a wide variety of modifications thereto may be effected by persons skilled in the art without departing from the spirit and scope of the invention as set forth in the following claims.

What is claimed is:

1. A service means for providing luggage containers, comprising the steps of:
a. setting up a luggage management organization having ownership and management authority of luggage containers;
b. according to a user's journey needs, acquiring user right of an agreed period for a certain quantity of luggage containers from the above luggage management organization; and
c. returning the luggage containers to the luggage management organization after use by the user.

2. The service means for providing luggage containers according to claim 1, wherein the user acquires the user right for the luggage containers through payments.

3. The service means for providing luggage containers according to claim 1, wherein the user acquires the user right for the luggage containers for free.

4. The service means for providing luggage containers according to claim 1, wherein the luggage management organization delivers the luggage containers to a location designated by the user after the luggage management organization accepts authorization given by the user.

5. The service means for providing luggage containers according to claim 1, wherein the user picks up the luggage containers from the luggage management organization after the luggage management organization accepts authorization given by the user.

6. The service means for providing luggage containers according to claim 1, wherein the luggage management organization is responsible for delivering the luggage containers from a designated location to a location of luggage departure or from a location of luggage departure to a designated location after the user acquires and packs the luggage containers.

7. The service means for providing luggage containers according to claim 1, wherein the luggage management organization provides customers with luggage containers of suitable designs, specifications and colors according to customers' needs.

8. The service means for providing luggage containers according to claim 1, wherein the luggage containers have areas for placing identification logos and advertisements.

9. The service means for providing luggage containers according to claim 1, wherein the luggage containers are disposed with identification devices or records.

10. The service means for providing luggage containers according to claim 1, wherein the luggage management organization establishes branch offices at places around the world.

11. The service means for providing luggage containers according to claim 1, wherein the luggage management organization provides the user with emergency luggage whenever necessary.

12. The service means for providing luggage containers according to claim 1, wherein the luggage management organization purchases goods upon the user's request and packs the purchased goods in the luggage containers.

13. The service means for providing luggage containers according to claim 12, wherein the luggage management organization delivers the purchased goods upon the user's request to locations designated by the user.
